(19) United States
(12) Patent Application Publication
(10) Pub. No.: US 2019/0297850 A1
(43) Pub. Date: Oct. 3, 2019

(54) Tear N Lair

(71) Applicant: Steven Ortiz, bronx, NY (US)

(72) Inventor: Steven Ortiz, bronx, NY (US)

(21) Appl. No.: 16/283,822

(22) Filed: Feb. 25, 2019

Related U.S. Application Data
(60) Provisional application No. 62/651,073, filed on Mar. 30, 2018.

(51) Int. Cl. A01K 15/02; D21H 11/12

(52) U.S. Cl. CPC A01K 15/026; A01K 2227/105; D21H 11/12

(57) ABSTRACT

Rodents have incisors that continuously grow and need to be worn down over time. Tear N lair consists of pulp, wood and cotton all combined to make 1 sheet of paper. When the pulp, wood and cotton is combined this creates a gnawing object of different grades of material allowing for proper wear on the incisors of a rodent. The process involves creating and forming layers of fibrous material from a pulp base that when combined create a fibrous wood and cotton paper. This process is creating a material of paper that can be layered with cotton, wood and other forms of paper. Added forms of paper may be soft or harder in grade. Added forms of paper may include shredded paper or wax paper. When joined these materials create layers that allow rodents to tear, shred and separate. Layers that are separated can also be used as a laying material allowing the rodent to rest on top. The separated material creates a cushion of padding.

When pulp, wood and cotton are combined a form of paper is created to wear down the incisors of rodents. This process involves adding layers of cotton, wood and pulp and mixing into one actual layer which forms one sheet. When all the materials are added it creates one entire sheet of paper. There are different forms of strengths created by combining wood, cotton and paper. The thickness of the paper varies by the forming process. Once a sheet is given to a rodent they will gnaw and chew. The sheet will be shredded and torn into pieces. This sheet will help reduce the length of the incisors if given in moderate amounts. The wood layer allows the incisors to wear down while the pulp and cotton allow the wood to be held firm in place. A fresh sheet should be given every week. Once the material is broken down the rodent will create many pieces of material that can be grouped and made into a form of padding in which the rodent can then use to burrow or lay on top of.

### BRIEF DESCRIPTION OF DRAWINGS

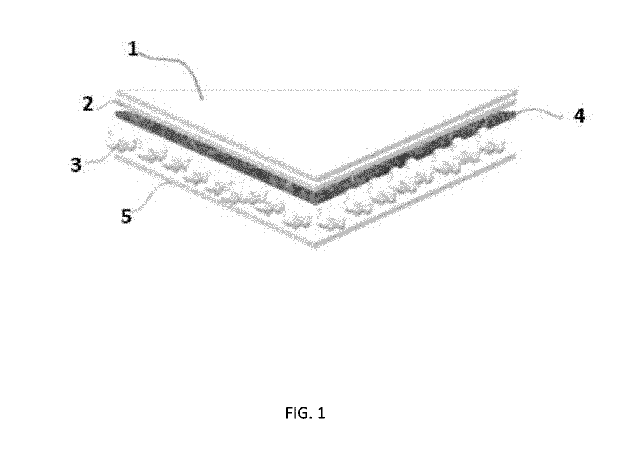

FIG. 1 is a front angle view of an inside view of layers that form one sheet of paper
Number 1 is a layer of fibrous material
Number 2 is a layer of wax material
Number 3 is a layer of cotton material
Number 4 is a layer of shredded wood or whole wood material
Number 5 is a layer of fibrous material

I claim:

1) A single sheet of paper with improved strength comprising:
a. Layers of cotton, wood and pulp mixed into one actual layer which forms one sheet.
b. the process of forming and combining cotton, wood and pulp into 1 sheet creating 1 final layer.
c. the use of cotton, wood and pulp in 1 sheet as a rodent gnawing object allowing for the reduction in side of incisors.
